(19) United States
(12) Patent Application Publication
(10) Pub. No.: US 2005/0104385 A1
(43) Pub. Date: May 19, 2005

(54) Safety toggle bolt

(76) Inventors: Karl Guthrie, Austin, TX (US); Joseph Schwartz, Wimberley, TX (US)

Correspondence Address: BIRDWELL & JANKE, LLP, 1100 SW SIXTH AVENUE, SUITE 1400, PORTLAND, OR, 97204, US

(21) Appl. No.: 10/718,929

(22) Filed: Nov. 19, 2003

(51) Int. Cl. E05C 5/00

(52) U.S. Cl. 292/247

(57) ABSTRACT

A safety toggle bolt. According to one aspect of the invention, a safety toggle bolt according to the invention includes a flexible cable having a proximal end having an anchoring attachment, and a toggle bar pivotally connected to a distal end of the cable. The toggle bar is adapted for pivoting between a closed position for insertion through the hole into the opening space and an open position in which the toggle bar cannot be withdrawn from the opening space back through the hole.

### FIELD OF THE INVENTION

The present invention relates to a safety toggle bolt, particularly for use in anchoring to pre-cast concrete slabs and other construction and building materials, to provide fall protection for workers as well as providers of emergency services.

### BACKGROUND

It is sometimes necessary for workers in the construction industry, and for providers of emergency services such as fire, police and rescue, to work high above the ground. It is a practical necessity, and often a legal requirement, to provide fall protection for such workers. For example, the American National Safety Standard Institute (“ANSI”) provides specific standards for fall protection.

However, it is recognized herein that existing devices provided for this purpose are not suitable for anchoring to concrete. For example, existing devices transmit too much force, or transmit force in such a way, that they overstress thin-wall concrete, which is brittle and weak in shear. Existing devices are also not adjustable to accommodate different object thicknesses, and therefore must be provided in specific sizes which cannot be used repeatedly in multiple applications.

Accordingly, there is a need for a safety toggle bolt adapted for anchoring to relatively weak or thin wall materials, as well as a safety toggle bolt providing improved ease and flexibility of use.

### SUMMARY

A safety toggle bolt according to the present invention is disclosed herein, for anchoring to an object having a hole therethrough leading to an opening space. According to one aspect of the invention, a safety toggle bolt according to the invention includes a flexible cable having a proximal end having an anchoring attachment, and a toggle bar pivotally connected to a distal end of the cable. The toggle bar is adapted for pivoting between a closed position for insertion through the hole into the opening space and an open position in which the toggle bar cannot be withdrawn from the opening space back through the hole.

According to another aspect of the invention, a safety toggle bolt according to the invention includes an elongate handle member having a proximal end having an anchoring attachment, a toggle bar pivotally connected to a distal end of the handle member, and a hole plug. The toggle bar is adapted for pivoting between a closed position for insertion through the hole into the opening space and an open position in which the toggle bar cannot be withdrawn from the opening space back through the hole. The handle member defines an elongate axis. The hole plug is movable in the direction of the axis with respect to the handle member. The plug has a plugging portion for centering the plug in the hole and a lip portion for fixing the position of the plug against the object.

According to yet another aspect of the invention, a safety toggle bolt according to the invention includes an elongate handle member having a proximal end having an anchoring attachment, a toggle bar pivotally connected to a distal end of said handle member, a hole plug, and an elongate toggle bar pivot control member. The hole plug is slidingly received by the handle member. The plug has a plugging portion for centering the plug in the hole and a lip portion for fixing the position of the plug against the object. The handle member defines an elongate axis. The toggle bar pivot control member is movable in the direction of the axis with respect to the handle member. The toggle bar pivot control member has a handle end accessible outside the hole and a control end attached to the toggle bar, for pivoting the toggle bar between a closed position for insertion through the hole into the opening space and an open position in which the toggle bar cannot be withdrawn from the opening space back through the hole.

According to a method of use aspect of the invention, a safety toggle bolt having a handle member and a toggle bar pivotally connected to the handle member is provided. The toggle bar is locked in a closed position. The safety toggle bolt is inserted through a hole. The handle member is pushed so as to unlock the toggle bar from the closed position, wherein the toggle bar automatically opens to an open position.

According to another method of use aspect of the invention, a safety toggle bolt having having a handle member, a toggle bar pivotally connected to the handle member, and a hole plug is provided. The toggle bar is locked in a closed position. The safety toggle bolt is inserted through a hole so as to seat the hole plug in the hole. The handle member is pushed so as to unlock the toggle bar from the closed position. The handle member is subsequently released, wherein the toggle bar is automatically pulled toward the hole plug, to automatically adjust the safety toggle bolt to the depth of the hole.

The foregoing and other objects, features and advantages of the present invention will be more readily understood upon consideration of the following detailed description of the invention, taken in conjunction with the following drawings.

### BRIEF DESCRIPTION OF THE DRAWINGS

FIG. 1 is a pictorial view of a safety toggle bolt according to the present invention.

FIG. 2A is a pictorial view of the safety toggle bolt of FIG. 1, with a toggle bar thereof according to the invention in a closed position.

FIG. 2B is a side elevation of the safety toggle bolt of FIG. 1 in the position shown in FIG. 2, for insertion into a hole through an object.

FIG. 2C is a side elevation of the safety toggle bolt of FIG. 1 after insertion into the hole through the object, with the toggle bar of FIG. 2A in an open position.

FIG. 2D is a side elevation of the safety toggle bolt of FIG. 1 after insertion into the hole through the object, with the toggle bar of FIG. 2C still in the open position and seated on the object.

FIG. 2E is a side elevation of the safety toggle bolt of FIG. 1 after insertion into the hole through the object, with the toggle bar of FIG. 2A in the closed position.

FIG. 3 is a top view of the toggle-bar of FIG. 2A in the open position, showing a toggle bar return spring according to the present invention.

FIG. 4 is a top view of the toggle bar of FIG. 2A in the closed position, with ends of the toggle bar disposed in a recess in a hole plug according to the present invention, for locking the toggle bar in the closed position.

### DETAILED DESCRIPTION

The safety toggle bolt described herein is particularly advantageous for use in anchoring to concrete objects. For example, in the construction industry large pre-cast concrete slabs are used. The concrete slabs have varying thicknesses. When working with these slabs high above the ground, construction workers and others need fall protection; however, there is currently no fall protection available that is particularly adapted for use with these concrete slabs. For example, anchors for providing fall protection should place minimal shear stress on the concrete, because concrete is weak in shear, and the anchors should be securely adaptable to varying thicknesses. It is also desired to easily install and remove the anchors, so that the same anchor can be used and reused. However, it should be understood that safety toggle bolts according to the present invention may be employed for anchoring to any object, for any purpose, so that all of the advantages of the invention do not need to be realized.

To prepare an object for use with the present invention the object must be provided with a hole, preferably a round, drilled hole. However, it should be understood that safety toggle bolts according to the present invention may be adapted for any shape hole.

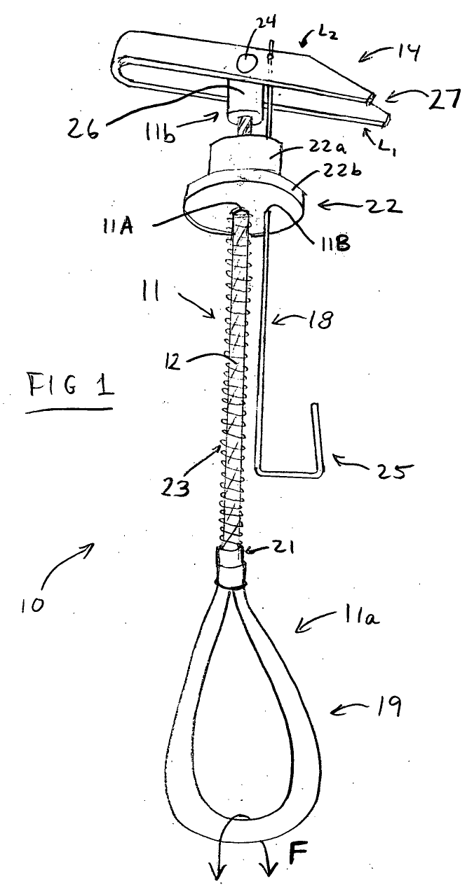

Turning now to FIG. 1, a safety toggle bolt 10 according to the present invention is shown. The bolt 10 includes a handle member 11 which preferably is preferably formed of a flexible wire cable 12, although other cable materials could be used. The cable is sufficiently strong to provide adequate fall protection, while the flexibility of the cable provides for minimizing the transfer of shear forces to the object, which is especially advantageous when the object is weak in shear, or has relatively thin walls, such as the pre-cast concrete slabs used for building construction.

The handle member 11 has a proximal end 11a that is configured for receiving a tying cable, or alternatively for grasping by a user of the bolt, such as by turning the cable into an eye 19 as shown. Any equivalent shape, adaptation or configuration of the proximal end of the handle member 11, such as by use of one or more hooks, bolts, or clamps, may be used to form anchoring attachments to the bolt 10 without departing from the principles of the invention.

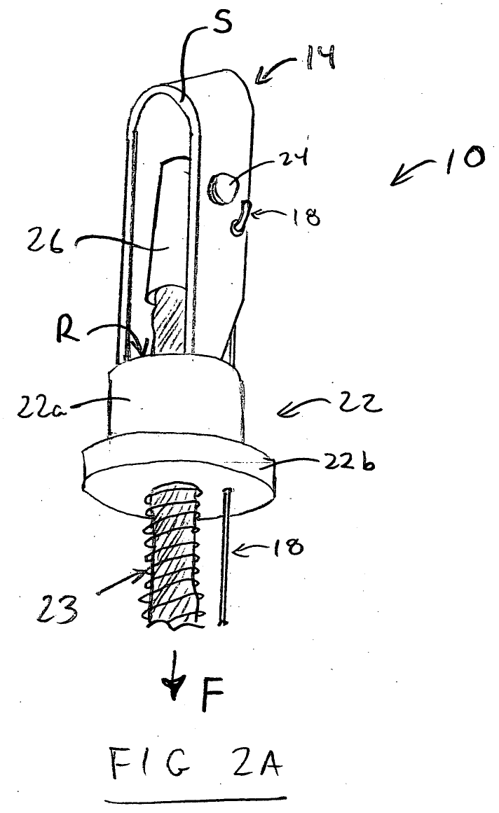

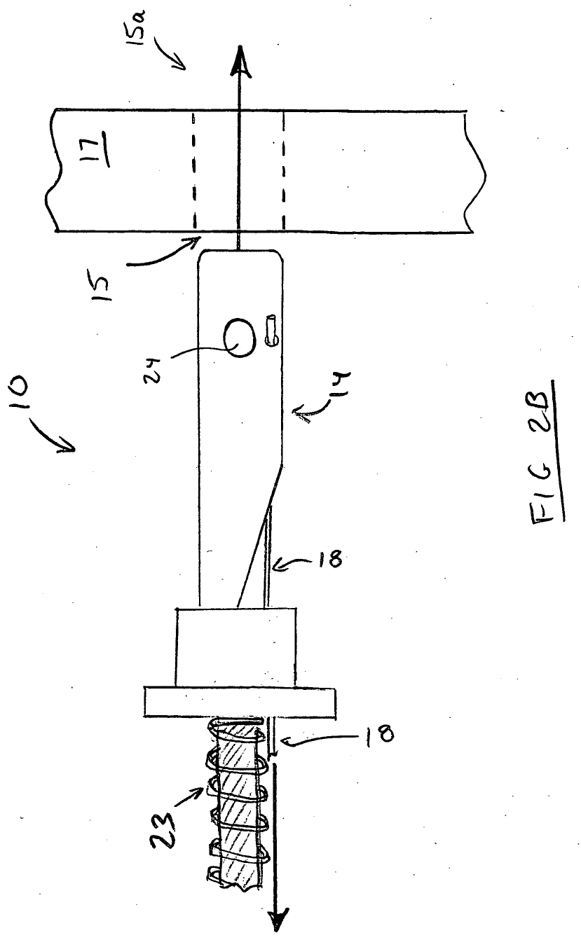

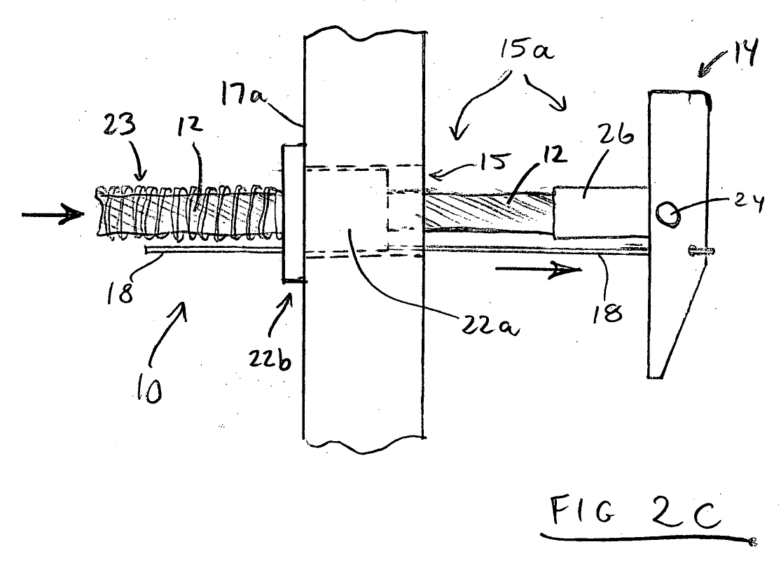

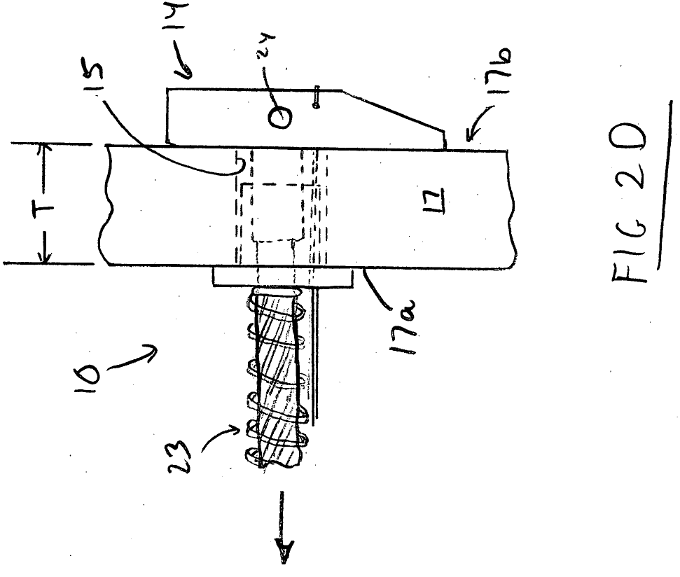

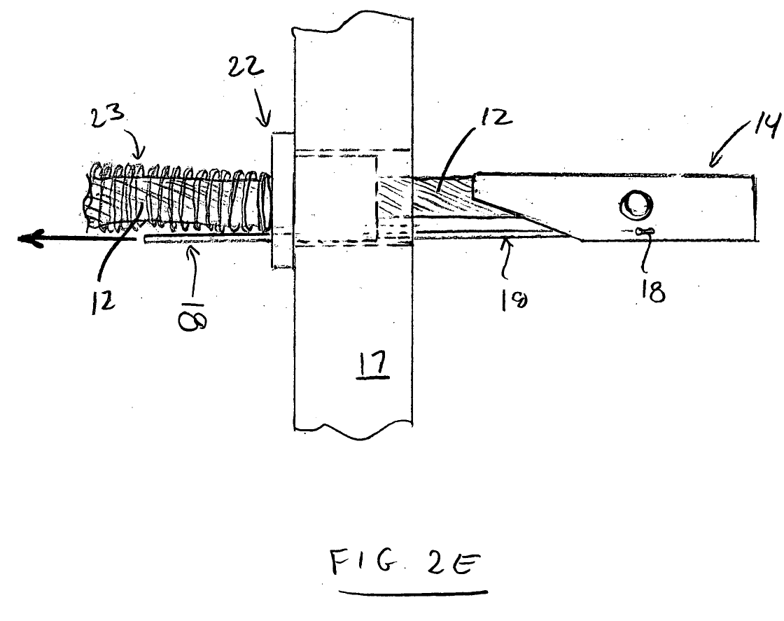

The handle member 11 has a toggle bar 14 pivotally connected to a distal end 11b thereof. The toggle bar 14 is provided for pivoting between two positions. Referring to FIG. 2A, the toggle bar is shown in a closed position. Referring to FIG. 2B, the toggle bar in its closed position can be inserted through a hole 15 through an object 17 into an opening space 15a behind the object. Referring to FIG. 2C, the toggle bar is opened into an open position in the opening space 15a and, referring to FIG. 2D, the toggle bar is seated on a back surface 17b of the object 17, so that the toggle bar cannot be withdrawn from the opening space back through the hole. Thence, the toggle bar anchors the bolt 10 to the object.

More particularly, referring back to FIG. 2A, a proximal surface S of the toggle bar 14 bears on the back surface 17b (FIG. 2D), hence, the surface S is preferably as large as is deemed practical to reduce the stress resulting from a given force “F” (FIGS. 1 and 2A) transmitted by the handle member. One simple way to do this is to provide the toggle bar as a U-shaped member such as shown in FIGS. 1 and 2A which effectively forms two legs (L₁ and L₂ in FIG. 1). The toggle bar may be attached to the distal end of the handle member 11 by a pin 24 extending through a shank 26 that terminates the handle member, such that the handle member 11 is centrally located between the two legs of the toggle bar. The U-shape provides for strengthening the toggle bar and reducing the transmitted force by half, while the central disposition provides a symmetry that eliminates twisting and ensures smooth operation.

A toggle bar pivot control member 18 is provided to control the pivoting of the toggle bar 14 between the open and closed positions. The control member 18 extends from the toggle bar to a point of user access outside the hole 15 and is formed of a stiff material, such as heavy gauge metal wire. Pushing the control member 18 in the direction indicated in FIG. 2C pivots the toggle bar from the closed position shown in FIG. 2B to the open position. Conversely, pulling the control member 18 away from the hole 15 along the direction indicated in FIG. 2B pivots the toggle bar to its closed position. The toggle bar pivot control member 18 preferably includes a finger-loop portion 25 (FIG. 1) by which a user can easily manipulate the control member.

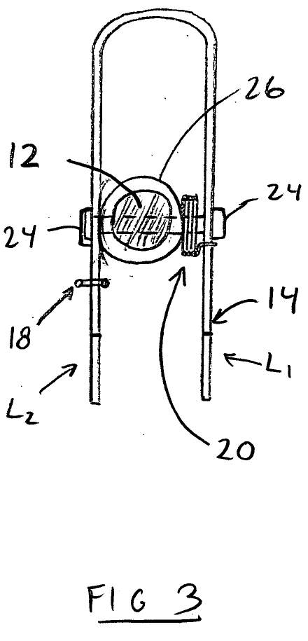

Turning to FIG. 3 showing a top view looking down on the bolt 10 with the toggle bar 14 in its open position, a toggle bar return spring 20 is preferably provided for biasing the toggle bar in the open position, so that the bolt 10 opens automatically after insertion. The return spring may be a coiled torsion spring such as shown, or may be a cam and leaf spring or any other spring configuration that is desired.

The bolt 10 further includes a hole plug 22. The plug 22 has a hole plugging portion 22a and a lip portion 22b. The hole plugging portion 22a is shaped to fit the hole 15, while the wider lip portion 22b is adapted to seat the hole plug on the object, by coming to rest against the outer surface 17a of the object. In the preferred configuration of the plug shown, in which the hole 15 is substantially or completely filled by the plug, both the handle member 11 and the toggle bar pivot control member 18 extend through the plug, through corresponding apertures 11A and 18A (FIG. 1). Preferably, the members 11 and 18 slide in the apertures, but the apertures may be substantially larger than the respective members if desired. If the plug only partially fills the hole, one or both of the members 11 and 18 would not need to extend through the plug but could extend beside it, either against an outer periphery of the plug or spaced away from the outer periphery of the plug.

Preferably, a plug biasing spring 23 is provided for biasing the hole plug 22 into the hole, in the direction of the toggle bar 14. By this action, the toggle bar 14 is biased toward the hole plug, which provides the important and outstanding advantage of adjusting the bolt 10 to objects 17 of varying thickness “T” (FIG. 2D). Shown is a compression coil spring concentrically disposed about the handle member 11, but other biasing configurations are possible. As seen in FIG. 1, the spring 24 bears on the plug 22, at one end, and on a suitable adaptation 21 of the handle member 11 at the other.

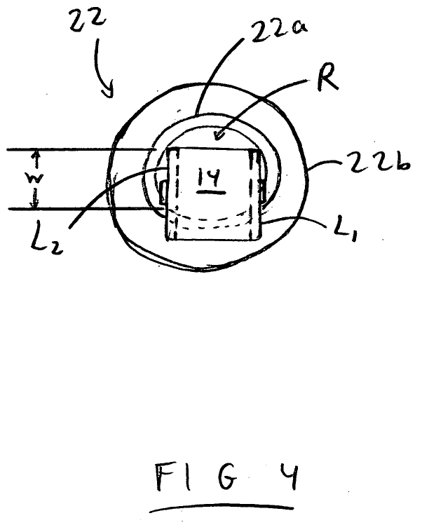

Referring back to FIG. 2A, the hole plug 22 preferably includes a recess “R” for receiving an end 27 (FIG. 1) of the toggle bar 14 that defines the proximal end of the toggle bar when the toggle bar is in its closed position. The recess captures the end 27, particularly the ends of the legs L₁ and L₂ of the preferred toggle bar 14, to hold the toggle bar in the closed position until it is released by pulling the hole plug in the direction indicated. Releasing the toggle bar from the recess permits the spring 20 (FIG. 4) to then pivot the toggle bar to the open position.

FIG. 4 shows a plan view of the toggle bar 14 in the closed position, captured by the recess “R.” As is readily apparent, where the plug 22 is cylindrical, the end 26 of the toggle bar should have minimal width “W” for fitting inside the diameter of the recess. This can be accomplished with the profile shown in FIG. 1, or any desired profile that narrows suitably at the recess.

According to a preferred method of use of the bolt 10, the bolt is preferably first locked in the closed position by inserting the end 26 of the toggle bar 14 into the recess “R” of the hole plug 22 as shown in FIG. 2A. Then, the assembly is inserted through the hole 15, by use of the handle 11, as shown in FIG. 2B. The lip portion 22b of the plug will first come into contact with the outer surface 17a of the object. Continuing to push the handle member 11 into the hole will push the toggle bar 14 deeper into the opening space 15a, which compresses the spring 23 and releases the end 26 from the recess “R.” As soon as the toggle bar 14 clears the hole 15, the toggle bar return spring 20 automatically pivots the toggle bar to the open position shown in FIG. 2C. Alternatively, the control member 18 may be used to open the toggle bar. Releasing the handle member 11 then allows the plug biasing spring 23 to decompress and thereby pull the open toggle bar 14 toward the back surface 17b of the object, against the plug 22 as shown in FIG. 2D, thus automatically tightening the anchor.

To remove the toggle bolt from the object, the user pushes the handle member 11 until the toggle bar 14 has enough clearance with respect to the back surface 17b of the object, such as that shown in FIG. 2C, so that pulling the toggle bar pivot control member 18 can pivot the toggle bar to the closed position, as shown in FIG. 2E. Then, releasing the handle member 11 allows the plug biasing spring 23 to pull the end 26 of the closed toggle bar into the recess “R” of the plug 22 as shown in FIG. 2F. The bolt 10 may then be easily withdrawn from the hole 15 for future use in the opposite of the direction indicated in FIG. 2B.

Due to the unique configuration of the toggle bolt 10 described above, the spring 23 is able to bias the plug 22 to virtually any degree of spacing from the toggle bar 14, providing outstanding flexibility for mounting the bolt 10 through holes of varying thicknesses.

It is to be recognized that, while a particular safety toggle bolt and method for use thereof has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A safety toggle bolt for anchoring to an object having a hole therethrough leading to an opening space, comprising:
a handle member having a proximal end having an anchoring attachment;
a toggle bar pivotally connected to a distal end of said handle member, wherein said toggle bar is adapted for pivoting between a closed position for insertion through the hole into the opening space and an open position in which the toggle bar cannot be withdrawn from the opening space back through the hole; and
a toggle bar pivot control member, said pivot control member having a handle end accessible outside the hole and a control end attached to said toggle bar, for pivoting said toggle bar between said open position and said closed position, to enable withdrawal of said toggle bar from the opening space back through the hole.

2. The safety toggle bolt of claim 1, wherein said handle member comprises a flexible cable.

3. A safety toggle bolt for anchoring to an object having a hole therethrough leading to an opening space, comprising:
a handle member having a proximal end having an anchoring attachment;
a toggle bar pivotally connected to a distal end of said handle member, wherein said toggle bar is adapted for pivoting between a closed position for insertion through the hole into the opening space, and an open position in which the toggle bar cannot be withdrawn from the opening space back through the hole; and
a toggle bar return spring, attached to said toggle bar, for biasing said toggle bar in said open position.

4. The safety toggle bolt of claim 3, wherein said handle member comprises a flexible cable.

5. A safety toggle bolt for anchoring to an object having a hole therethrough leading to an opening space, comprising:
a handle member having a proximal end including an anchoring attachment;
a toggle bar pivotally connected to a distal end of said handle member, wherein said toggle bar is adapted for pivoting between a closed position for insertion through the hole into the opening space, and an open position in which the toggle bar cannot be withdrawn from the opening space back through the hole; and
a hole plug, said handle member slidably extending through said hole plug, said hole plug having a lip portion for fixing the position of said hole plug against the object, said hole plug being adapted such that said hole plug may be slidably moving on said handle member without causing said pivoting of said toggle bar.

6. The safety toggle bolt of claim 5, wherein said hole plug is further adapted to guide said handle member through said hole such that said handle member is substantially free of contact with the interior of said hole.

7. The safety toggle bolt of claim 5, further comprising an elongate toggle bar pivot control member, said pivot control member having a handle end accessible outside the hole and a control end attached to said toggle bar, for pivoting said toggle bar between said open position and said closed position, to enable withdrawal of said toggle bar from the opening space back through the hole.

8. The safety toggle bolt of claim 7, wherein said pivot control member slidably extends through said lip portion of said hole plug.

9. The safety toggle bolt of claim 8, wherein said pivot control member slidably extends entirely through said hole plug.

10. The safety toggle bolt of claim 7, wherein said hole plug is further adapted to guide said pivot control member through said hole such that said pivot control member is substantially free of contact with the interior of said hole.

11. The safety toggle bolt of claim 7, wherein said hole plug is further adapted to guide said handle member through said hole such that said handle member is substantially free of contact with the interior of said hole.

12. The safety toggle bolt of claim 11, wherein said handle member comprises a flexible cable.

13. The safety toggle bolt of claim 11, wherein said toggle bar, in said closed position, is adapted to fit into a recess in said plug, for holding said toggle bar in said closed position.

14. The safety toggle bolt of claim 13, wherein said handle member comprises a flexible cable.

15. The safety toggle bolt of claim 5, further comprising a plug biasing member for biasing said hole plug toward said toggle bar such that said hole plug and said toggle bar are urged against the object having a hole therethrough after said safety toggle bolt is inserted in the hole and said handle is released.

16. The safety toggle bolt of claim 15, wherein said plug biasing member is a spring.

17. The safety toggle bolt of claim 5, further comprising a toggle bar return member for biasing said toggle bar in said open position.

18. The safety toggle bolt of claim 17, wherein said toggle bar return member is a spring.

19. The safety toggle bolt of claim 17, further comprising a plug biasing member for biasing said hole plug toward said toggle bar such that said hole plug and said toggle bar are urged against the object having a hole therethrough after said safety toggle bolt is inserted in the hole and said handle is released.

20. The safety toggle bolt of claim 19, wherein said plug biasing member is a spring.

21. The safety toggle bolt of claim 5, wherein said handle member comprises a flexible cable.

22. The safety toggle bolt of claim 21, wherein said hole plug is further adapted to guide said handle member through said hole such that said handle member is substantially free of contact with the interior of said hole.

23. The safety toggle bolt of claim 5, wherein said toggle bar, in said closed position, is adapted to fit into a recess in said plug, for holding said toggle bar in said closed position.

24. The safety toggle bolt of claim 19, further comprising an elongate toggle bar pivot control member movable in the direction of said axis with respect to said handle member, said pivot control member having a handle end accessible outside the hole and a control end attached to said toggle bar, for pivoting said toggle bar between said open position and said closed position, to enable withdrawal of said toggle bar from the opening space back through the hole.

25. The safety toggle bolt of claim 24, wherein said handle member comprises a flexible cable.

26. A method for anchoring to an object having a hole therethrough leading to an opening space, comprising:
providing a safety toggle bolt having a handle member and a toggle bar pivotally connected thereto and a toggle bar biasing member;
disposing said toggle bar in a closed position for inserting the toggle bolt through the hole and into the open space; and
pushing on said handle member so as to space said toggle bar from the hole sufficiently to permit said toggle bar biasing member to pivot said toggle bar into an open position in which said toggle bar cannot be withdrawn from the opening space through the hole.

27. The method of claim 26, further comprising providing a hole plug and a hole plug biasing member, and releasing said handle member wherein said step of releasing includes seating said hole plug on the hole and biasing said toggle bar towards said hole plug.

28. The method of claim 27, wherein said step of disposing said toggle bar in said closed position includes locking said toggle bar in said closed position, wherein said step of pushing on said handle member includes automatically unlocking said toggle bar from the locked closed position.

29. The method of claim 28, wherein said step of locking said toggle bar in said closed position includes engaging an end of said toggle bar with said hole plug.

30. The method of claim 29, wherein said step of engaging an end of said toggle bar with said hole plug includes inserting said end in a recess in said hole plug.

31. The method of claim 27, wherein said hole plug biasing member comprises a spring.

32. The method of claim 26, wherein said toggle bar biasing member comprises a spring.

33. The method of claim 26, further comprising removing said safety toggle bolt from the hole by returning said toggle bar to said closed position for withdrawal from the hole.
